(19) United States
(12) Patent Application Publication
(10) Pub. No.: US 2026/0147975 A1
(43) Pub. Date: May 28, 2026

(54) Ordered Derivations of Canonical Forms

(71) Applicant: Gavin Burke, Bellevue, WA (US)

(72) Inventor: Gavin Burke, Bellevue, WA (US)

(21) Appl. No.: 19/452,251

(22) Filed: Jan. 17, 2026

(51) Int. Cl. G06F 40/154

(52) U.S. Cl. CPC G06F 40/154

(57) ABSTRACT

A formal system effects ordered derivations of canonical forms with inductive formation rules. A logical connective understood as ordered conjunction, denying the proof-theoretic structural law of exchange in a substructural setting, concatenates terms occurring at successive internal nodes of a proof tree until a defined pattern is matched and a canonical form is thus obtained. Leaf nodes classify subterms by their semantic types, and syntactic composition occurs at internal nodes to determine the canonical form. The framework admits normalization of structured data, deriving consistent representations for terms with many possible encodings.

### TECHNICAL FIELD

This disclosure relates generally to formal systems effecting ordered derivations of canonical forms with inductive formation rules.

### BACKGROUND

Information typically enjoys many possible representations. Variability in these representations can complicate its parsing and impose unnecessary overhead in its comprehension. In settings where constituent pieces of information admit a formal classification judgment, a canonical representation of the information as a whole becomes admissible: subterms can then be formally arranged according to their types to match a well-defined pattern. The basis for the formation of such a pattern may, however, be opaque in the absence of a constructive proof, obscuring the relationship between the typing rules and the derived term. In practice, this means that a compiler of uniformly structured information cannot easily be recognized and given proper attribution for the definition of an elegant inductively defined form that the information realizes.

### SUMMARY

In view of the foregoing, a formal system effecting ordered derivations of canonical forms for typed terms is defined. A logical connective understood as ordered conjunction, denying the proof-theoretic structural law of exchange in a substructural setting, concatenates terms occurring at successive internal nodes of a proof tree until a defined pattern is matched and a canonical form is thus obtained. Leaf nodes classify subterms by their semantic types, and syntactic composition occurs at internal nodes to determine the canonical form. The framework admits normalization of structured data, deriving consistent representations for terms with many possible encodings. Hence it is resolved that, in the setting of a compilation of uniformly structured information, the inductive structure realized by the information can be studied and understood by its reader, and proper recognition for its expressive structuring can be readily attributed to its compiler.

### BRIEF DESCRIPTION OF THE DRAWINGS

FIGS. 1-3 give example ordered typing derivations for the canonicalization of string-encoded information in intuitionistic natural deduction.

### DETAILED DESCRIPTION OF PREFERRED EMBODIMENTS

The preferred embodiments can be understood as realizing a substructural type system denying the proof-theoretic structural law of exchange, with exchange informally stating that the order of premises in a formal proof does not affect derivability as premises can be appealed to in arbitrary order. The formal system described herein regards the order of premises by concatenating subterms in the order in which they appear, admitting pattern matching over subterms to form a larger, canonicalized string term. For compactness, the logical connective of ordered conjunction is left implicit in the derivations presented and is witnessed only by the concatenation of subterms appearing in the subtree rooted at the internal node where concatenation occurs, with intermediate subterms possibly interposed between them.

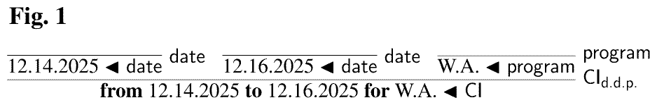

FIG. 1 gives an example ordered typing derivation for the canonicalization of string-encoded information in intuitionistic natural deduction, realized in a tree comprising three axioms and one nonaxiom inference rule. Leaf nodes classify subterms by their semantic types, and the root node classifies a string term as CI, abbreviating canonicalized information, for the pattern it matches. The axioms classify 12.14.2025 as date, 12.16.2025 as date, and W.A. as program. The ordered conjunction of these three terms, interposing the from-to-for fixed literals, is formed to obtain the canonicalized string constant “from 12.14.2025 to 12.16.2025 for W.A.” matching the pattern d.d.p.

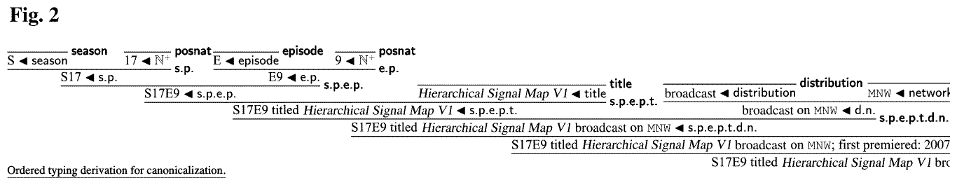

FIG. 2 gives another example ordered typing derivation for the canonicalization of string-encoded information in intuitionistic natural deduction. For space reasons, only the left portion of the derivation tree is visible, which is sufficient for explanatory purposes. Leaf nodes classify subterms by their semantic types, while internal nodes classify terms by the patterns they match. For example, the string constant “Hierarchical Signal Map V1” occurring in a leaf is classified as title, while “E9” is classified as matching the pattern e.p. for concatenating a term classified as episode and a term classified as [symbol] . With certain specialized rules, an intermediate term may be interposed between two other terms appearing in the premises of a given rule application as part of ordered conjunction; for example, titled is interposed between “S17E9” and “Hierarchical Signal Map V1” as part of the rule application labeled s.p.e.p.t., thereby deriving a term assigned a classification having the same name. Terms gradually concatenate until a defined pattern is matched and a canonical form is thus obtained. The string-encoded information realizing the canonical form may appear in a compilation comprising multiple instances of related canonicalized information, each instance having an associated ordered derivation forming the basis for its canonicalization.

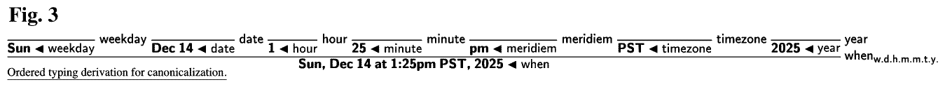

FIG. 3 gives a third example ordered typing derivation for the canonicalization of string-encoded information in intuitionistic natural deduction, realized in a tree with seven axioms and one nonaxiom inference rule. Each of the seven axioms classify terms by their semantic types, specifically classifying “Sun” as weekday, “Dec 14” as date, “1” as hour, “25” as minute, “pm” as meridiem, “PST” as timezone, and “2025” as year. The term occurring in the only internal node, the root node, concatenates the above seven subterms with intermediate subterms interposed between them to obtain the canonicalized string constant “Sun, Dec 14 at 5:20 pm PST, 2025” matching the pattern w.d.h.m.m.t.y. and classified as when. (The intrinsic order of the substructural calculus disambiguates the two occurrences of m.) In certain embodiments, internal nodes may classify terms by their semantics; for example, with “Dec” and “14” classified as month and day, respectively, “Dec 14” could be typed as date in an internal node having the foregoing two classification judgments as premises. Depending on the embodiment, multiple applicable formation rules may be evaluated, with a rule selected based on a priority or precedence relation, and the set of formation rules may be extensible to include user-defined rules.

### Implementation Options

It should be understood that the example embodiments described herein may be implemented in many different ways. The embodiments may be implemented by data processors located within personal or business computers, servers, tablets, mobile devices, embedded machines, and other computer systems. In some instances, the various “data processors” may each be implemented by a physical or virtual general-purpose computer having a central processor, memory, disk or other mass storage, communication interface(s), input/output (I/O) device(s), and other peripherals. The general-purpose computer is transformed into the processors and executes the methods described herein, for example, by loading software instructions into the computer, and then causing execution of the instructions to carry out the functions described.

As is known in the art, such a computer may contain a system bus, where a bus is a set of hardware lines used for data transfer among the components of a computer or processing system. The bus or busses are essentially shared conduit(s) that connect different elements of the computer system (e.g., one or more central processing units, disks, various memories, input/output ports, network ports, etc.) that enables the transfer of information between the elements. One or more central processor units are attached to the system bus and provide for the execution of computer instructions. Also attached to the system bus are typically I/O device interfaces for connecting the disks, memories, and various input and output devices. Network interface(s) allow connections to various other devices attached to a network. One or more memories provide volatile and/or non-volatile storage for computer software instructions and data used to implement an embodiment. Disks or other mass storage provides non-volatile storage for computer software instructions and data used to implement, for example, the various procedures described herein. Embodiments may therefore typically be implemented in hardware, custom designed semiconductor logic, Application Specific Integrated Circuits (ASICs), Field Programmable Gate Arrays (FPGAs), firmware, software, or any combination thereof.

In certain embodiments, the procedures, devices, and processes described herein are a computer-program product, including a computer-readable medium (e.g., a removable storage medium such as one or more DVD-ROMs, CD-ROMs, diskettes, tapes, etc.) that provides at least a portion of the software instructions for the system or the method. Such a computer-program product can be installed by any suitable software installation procedure, as is well known in the art. In another embodiment, at least a portion of the software instructions may also be downloaded as application software over a cable, communication network, and/or wireless connection from a server to a personal computer, tablet, or other data-processing device.

Embodiments may also be implemented as instructions stored on a non-transient machine-readable medium, which may be read and executed by one or more procedures. A non-transient machine-readable medium may include any mechanism for storing or transmitting information in a form readable by a machine (e.g., a computing device). For example, a non-transient machine-readable medium may include read-only memory (ROM); random-access memory (RAM); storage including magnetic disk storage media; solid state drives; optical storage media; flash memory devices; and others.

Furthermore, firmware, software, routines, or instructions may be described herein as performing certain actions and/or functions. However, it should be appreciated that such descriptions contained herein are merely for convenience and that such actions in fact result from computing devices, processors, controllers, or other devices executing the firmware, software, routines, instructions, etc. Accordingly, further embodiments may also be implemented in a variety of computer architectures, physical, virtual, remote computers, and/or some combination thereof, and thus the computer systems described herein are intended for purposes of illustration only and not as a limitation of the embodiments.

The above description has particularly shown and described example embodiments. However, it will be understood by those skilled in the art that various changes in form and details may be made therein without departing from the legal scope of this patent as encompassed by the appended claims.

1. A method for representing the normalized structure of string-encoded information realizing a canonical form, the canonical form defined by inductive formation rules, the method comprising:
processing an instance of string-encoded information realizing the canonical form;
associating with the string-encoded information an ordered derivation represented as a tree data structure, the ordered derivation comprising:
a plurality of leaf nodes, each such leaf node containing a subterm appearing in the canonical form and classified according to a semantic type;
one or more internal nodes, each such internal node realizing a syntactic composition of terms in its branch by concatenating a plurality of subterms occurring in the subtree rooted at the respective internal node, optionally interposing one or more intermediate subterms; and
a root node containing the canonical form, the canonical form including, as ordered subterms, the subterms appearing in the leaf nodes and in one or more internal nodes of the ordered derivation.

2. The method as recited in claim 1, wherein the tree has depth at least three.

3. The method as recited in claim 1, wherein the tree has at least three leaves.

4. The method as recited in claim 1, wherein the tree has at least two internal nodes.

5. The method as recited in claim 1, wherein the tree has at least three subtrees.

6. The method as recited in claim 1, wherein the canonical form is uniquely determined for a given collection of subterms.

7. The method as recited in claim 1, wherein the subterms occurring in the leaves are strings encoding natural language.

8. The method as recited in claim 1, wherein the subterms occurring in the internal nodes are strings encoding natural language.

9. The method as recited in claim 1, wherein the term occurring in the root node is a string encoding natural language.

10. The method as recited in claim 1, wherein the root node is the sole internal node.

11. The method as recited in claim 1, further comprising generating the ordered derivation programmatically by a computing device.

12. The method as recited in claim 1, further comprising rendering the ordered derivation for visual inspection.

13. The method as recited in claim 1, further comprising visually rendering the ordered derivation in response to interaction with the canonicalized string-encoded information.

14. The method as recited in claim 1, further comprising presenting the canonicalized string-encoded information as part of a compilation comprising multiple instances of canonicalized information, each instance having an associated ordered derivation forming the basis for its canonicalization.

15. The method as recited in claim 1, further comprising classifying one or more terms occurring in the internal nodes by their semantics.

16. The method as recited in claim 1, further comprising classifying one or more terms occurring in the internal nodes by the structural pattern formed by subterms in the subtree rooted at the respective internal node.

17. The method as recited in claim 1, further comprising extending the inductive formation rules by user-defined rules.

18. The method as recited in claim 1, further comprising realizing the tree in the traditional presentation style of intuitionistic natural deduction.

19. A non-transitory computer-readable medium storing instructions that, when executed by a processor, cause performance of the method of claim 1.

20. A client, comprising:
a memory; and
a processor configured to execute instructions stored in the memory to cause the client to perform the method of claim 1.
